(19) United States
(12) Patent Application Publication
(10) Pub. No.: US 2004/0216384 A1
(43) Pub. Date: Nov. 4, 2004

(54) Door weather strip

(75) Inventors: Mitsunobu Teramoto, Nishikasugai-gun (JP); Hideaki Minoura, Nishikasugai-gun (JP)

Correspondence Address: POSZ & BETHARDS, PLC, 11250 ROGER BACON DRIVE, SUITE 10, RESTON, VA, 20190, US

(73) Assignee: TOYODA GOSEI CO., LTD.

(21) Appl. No.: 10/817,918

(22) Filed: Apr. 6, 2004

(30) Foreign Application Priority Data
Apr. 11, 2003 (JP) P2003-107921

(51) Int. Cl. E06B 7/16

(52) U.S. Cl. 49/479.1

(57) ABSTRACT

The lower rear corner portion of a weather strip for a front door is comprised by a molded portion. The molded portion has a base portion, a side wall portion extending from the base portion to the outer periphery, and a hollow seal portion integrally formed with the side wall portion. The base portion, which is curved corresponding to a mounting face nearly parallel with an outer circumferential surface of the front door, is attached thereto by clips. The seal portion is formed like a nearly squarish member in such a way as to correspond to the shape of a metal sheet part, whose shape in plan view is nearly squarish, of the lower rear portion of the front door. Inserts are embedded in the side wall portion. Parts corresponding to the inserts are attached to the front door by clips.

This application is based on Japanese Patent Application No. 2003-107921, which is incorporated herein by reference.

### BACKGROUND OF THE INVENTION

1. Field of the Invention

The present invention generally relates to a door weather strip, and more particularly to a door weather strip that comprises an extrusion portion attached to a periphery of an automobile door and also comprises at least a molded portion corresponding to a corner portion, and that is formed in a circular shape.

2. Description of the Related Art

Opening portions for allowing passengers to get on and off an automobile are formed in an automobile body. Doors each for closing and opening an opening portion correspond to and are formed at the opening portions, respectively. This weather strip has abase portion attached to a peripheral surface portion (for example, a retainer) of a door frame of a door, a side wall portion extending from the base portion toward the periphery thereof, and a hollow seal portion integrally formed with the side wall portion. When the door is closed, the seal portion elastically deforms to thereby seal between the door and the automobile body. Such a weather strip has elongated portions (for instance, nearly rectilinear portions) respectively corresponding to an upper side portion and a lower side portion, and also has corner portions respectively corresponding to door corner portions, at which the nearly rectilinear portions intersect with each other, so that the weather strip is formed in a circular shape. The elongated portions are molded by what is called an extrusion-molding method (that is, the elongated portions are extrusion portions), whereas the corner portions are molded by a die-molding method (that is, the corner portions are molded portions).

Generally, in consideration of stiffness of the automobile body, the corner portions of the opening portion are formed in such a way as to curve. Differently from this, in a case where there is a request to secure as large opening portions as possible, it is considered that each of the corner portions is formed to be squarish. In this case, even in each of corner portions of a weather strip, a sealing line is formed like a squarish curve. Especially, in a case of configuring front and rear doors as a French door, there is no other choice but to form (at least a sheet metal part of) a lower rear corner portion of the front door so that a shape in plan view (or side view) of the lower rear corner portion is nearly squarish. Thus, there is no other choice but to form a lower rear corner portion of a corresponding door weather strip so that a horizontal cross-section of the sealing line thereof is nearly squarish.

However, even in such a case, most of corner portions of each of members (for example, a reinforcing plate and an interior plate) composing the door are curved members. Usually, the squarish members are only sheet metal parts. In this case, although the base portion is attached to the curved part in the corner portions of the weather strip, stability of a position-state, that is, a mounting state of the seal portion is not necessarily sufficient.

Thus, it is considered that a nearly triangular resin piece serving as a separate element is attached to each of the corner portions of the weather strip (see, for example, JP-UM-A-63-37362).

However, in aforementioned related art, the separate resin piece is exposed in each of the corner portions. Thus, there is a fear of degradation in quality of appearance of the weather strip. Also, there is a fear that when closing stress is applied to the seal portion corresponding to the corner portion, a gap is formed between the weather strip and the resin piece, and that thus the related art lacks reliability in fastening (or connecting) both the weather strip and the resin piece.

### SUMMARY OF THE INVENTION

The invention is accomplished to solve aforementioned problems of the related art. Accordingly, an object of the invention is to provide a door weather strip, which is adapted so that at least one of corner portions is constituted by a molded portion, and which is enabled to stabilize a mounting state thereof and improve sealability thereof without degradation in quality of appearance thereof.

According to an aspect of the invention, there is provided a door weather strip (hereunder referred to as a first aspect of the invention) attachable to an outer periphery of an automobile door, and which comprises an extrusion portion and at least one molded portion corresponding to a corner portion. This weather strip has a hollow seal portion, and the seal portion is formed at least in the corner portion so that the shape in plan view of the seal portion is nearly squarish. Moreover, an insert is embedded in an inner peripheral portion of the seal portion.

According to the first aspect of the invention, in a molded portion at a corner portion of a door weather strip, a hollow seal portion is formed so that the shape in plan view of the seal portion is nearly squarish. Thus, in a case where a corner portion of an automobile door is nearly squarish, the seal portion fully extends over the outer periphery of the door. Consequently, the sufficient sealability of the door, which is in a closed state, is secured. On the other hand, a flat-plate-like insert is embedded in an inner peripheral portion thereof. Thus, sufficient stiffness of the corner portion is ensured. Consequently, the sealability can be enhanced. Additionally, the insert is embedded, therein differently from the related art according to which there is a fear that the appearance of the door is deteriorated by attaching a separate member thereto. Thus, deterioration in the quality of appearance can be prevented. Moreover, when the weather strip is attached to the automobile door at the parts, in which the inserts are embedded, the mounting state can be extremely stabilized. Incidentally, the expression “in plan view” may be replaced with the expression “in side view”. In short, this expression means that “viewed from a side surface of the automobile (hereinafter, it is the same with other aspect of the invention).

According to another aspect of the invention, there is provided a door weather strip (hereunder referred to as a second aspect of the invention) which comprises a base portion, attachable to an outer periphery of an automobile door, a side wall portion extending from the base portion to the outer periphery, and a hollow seal portion integrally formed with the side wall portion. This door weather strip is formed in a circular shape and comprises an extrusion portion and at least one molded portion corresponding to a corner portion. In this door weather strip, at least in the corner portion, the base portion is formed like a curved member, and the seal portion is formed so that shape in plan view of the seal portion is nearly squarish. Also, an insert is embedded in the side wall portion.

According to the second aspect of the invention, basically, the base portion is attached corresponding to nearly the outer periphery of an automobile door. Thus, the door weather strip is attached thereto. When the door is closed, the hollow seal portion elastically deforms, so that the sealability thereof is secured. Meanwhile, in the second aspect of the invention, the base portion is formed like a curved member, at least in a corner portion thereof. Thus, in a case where a part of the corner portion of the automobile door is a curved one, the weather strip can be attached thereto by providing this part along the base portion. Further, the seal portion is formed so that the shape in plan view thereof is nearly squarish. Thus, in a case that the shape in plan view of a part (for example, a sheet metal part) of the automobile door is almost squarish, the seal portion fully extends over the outer periphery of the door. Consequently, the sealability thereof in a closed state of the door is sufficiently secured. On the other hand, the distance between the base portion and the seal portion is relatively long at the squarish part and neighboring parts thereof. However, the inserts are embedded in the side wall portion provided therebetween. Thus, the stiffness of the corner portion is secured. Consequently, the sealability can be enhanced. Additionally, because the inserts are embedded therein, differently from the related art according to which there is a fear that the appearance of the door is deteriorated by attaching a separate member thereto, the second aspect can prevent deterioration in the quality of appearance. Moreover, in a case where the weather strip is attached to the automobile door at the parts, in which the inserts are embedded, the weather strip is attached thereto at the neighboring part of the seal portion. Thus, the mounting state can be extremely stabilized.

According to an embodiment (hereunder referred to as a third aspect of the invention) of the second aspect of the invention, at least in the corner portion, the base portion is attached to a mounting face, which is nearly parallel with an outer peripheral surface of the automobile door, by a clip.

According to the third aspect, the base portion is attached to the mounting face, which is nearly parallel with the outer peripheral surface of the automobile door, by the clip. Thus, the lowest limit mountability is secured. That is, a situation, in which a door weather strip is not attached to a corner portion, can be avoided.

In an embodiment (hereunder referred to as a fourth aspect of the invention) of one of the first to third aspect of the invention, a part corresponding to the insert is attached to the corner portion of the automobile door by mounting means.

According to the fourth aspect, the part corresponding to the insert is attached to the corner portion of the automobile door by the mounting means. That is, the door weather strip is attached thereto even at neighboring parts of the seal portion. Thus, the mounting state can extremely be stabilized. Incidentally, the mounting means may be a clip. The fourth aspect may be adapted so that the clip is attached to the sheet metal part of the corner portion of the automobile door.

According to an embodiment (hereunder referred to as a fifth aspect of the invention) of one of the first to fourth aspect of the invention, the automobile door is a front door. The part, in which said insert is embedded, is a lower rear corner portion.

According to the fifth aspect of the invention, the aforementioned advantages are obtained in a case where the lower rear corner portion of the front door is formed so that the shape in plan view thereof is nearly squarish.

According to an embodiment (hereunder referred to as a sixth aspect of the invention) of the fifth aspect of the invention, a rear door at the rear side of the front door is enabled as a French door together with the front door.

In a case where the front door and the rear door are provided as a French door, the lower rear corner portion of the front door should be formed so that the shape in plan view of the lower rear corner portion of the front door is almost squarish. Thus, the associated lower rear corner portion of the seal portion of the door weather strip should be formed so that the shape in plan view thereof is nearly squarish. Under such circumstances, the aforementioned advantages are obtained.

### BRIEF DESCRIPTION OF DRAWINGS

FIG. 1 is a schematic side view illustrating an outline configuration of an automobile to which an embodiment of the invention is applied;

FIG. 2 is a schematic view illustrating an outline configuration of a door weather strip;

FIG. 3 is a view mainly illustrating a lower rear corner portion of the weather strip;

FIG. 4 is a sectional view taken on line IV-IV in FIG. 3;

FIG. 5 is a sectional view taken on line V-V in FIG. 3;

FIG. 6 is a sectional view taken on line VI-VI in FIG. 3; and

FIG. 7 is a sectional view taken on line VII-VII in FIG. 3.

### DETAILED DESCRIPTION OF THE PREFERRED EMBODIMENTS

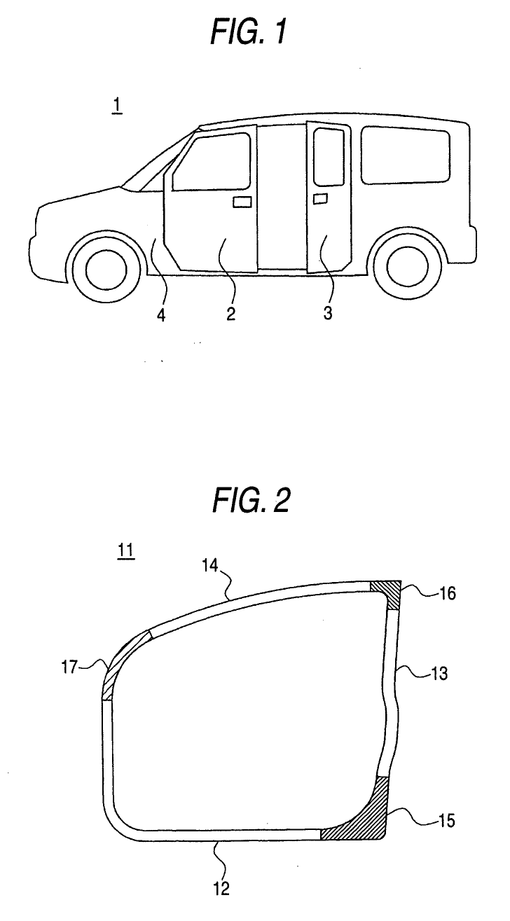

Hereinafter, an embodiment of the invention is described with reference to the accompanying drawings. As shown in FIG. 1, an automobile 1 according to this embodiment has a front door 2 and a rear door 3, both of which are adapted to open outward. That is, the front door 2 is openably and closably supported at a front portion of an opening, formed in an automobile body 4, for allowing passengers to get on and off the automobile. The rear door 3 is closably and openably supported at a rear portion of the opening. In this embodiment, the opening of the rear door 3 is permitted only when the front door 2 is in an open state. The closing of the front door 2 is permitted only when the rear door 3 is in a closed state. Thus, for convenience in outwardly opening both the doors 2 and 3, both the lower rear corner portion of the front door 2 and the lower front corner portion of the rear door 3 are approximately squarish. Consequently, the lower rear portion of the opening portion defined in a case in which the rear door 3 is in a closed state, and in which the front door 2 is in an open state, is nearly squarish.

Incidentally, this embodiment features a door weather strip to be attached to the front door 2. Thus, the following description centers on this door weather strip.

As shown in FIG. 2, the door weather strip (hereunder referred to simply as a “weather strip”) 11 to be attached to the front door 2 has three extrusion portions 12, 13, and 14 and three molded portions (indicated by scattered-point patterns in this figure) 15, 16, and 17. That is, the extrusion portions 12, 13, and 14 are elongatedly formed by an extruder (not shown). The molded portions 15, 16, and 17 are formed by the predetermined mold apparatus so that end parts of the adjacent extrusion portions 12, 13, (13, 14), (14, 15) are connected to each other. Each of these molded portions 12 to 17 is mainly made of a rubber material, such as EPDM, a thermoplastic elastomer, such as TPO, or a foamed material thereof.

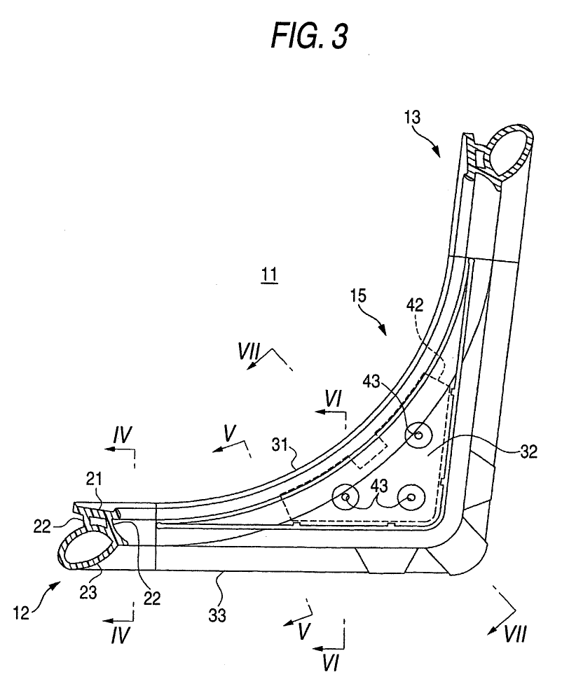

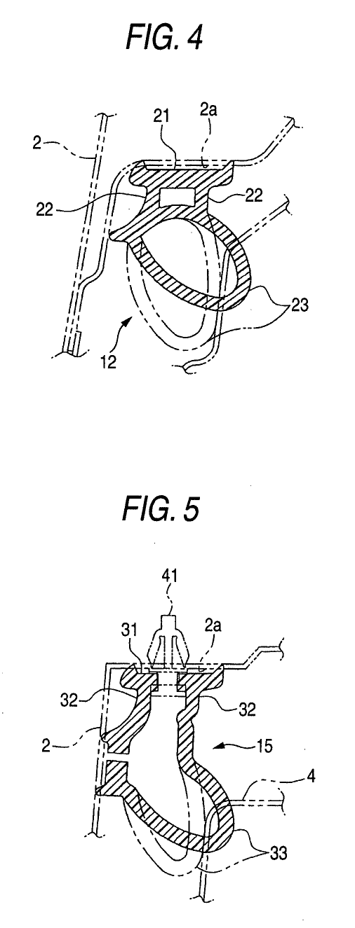

FIG. 4 is a sectional view taken on line IV-IV in FIG. 3. As shown in FIG. 4, the extrusion portion 12 (13, 14) comprises a base portion 21 to be fitted into a retainer (not shown) of the front door 2, or alternatively, to be attached to a mounting face 2a, which almost corresponds to the outer periphery of the front door 2, by clips at predetermined intervals, a side wall portion 22 extending from the base portion 21 toward the outer periphery, and a hollow seal portion 23 integrally formed with the side wall portion 22.

Similarly to the extrusion portions 12, 13, and 14, each of the molded portions 15, 16, and 17 has a base portion, and a hollow seal portion, though the base portion and the seal portion thereof differ in shape from those of the extrusion portions 12, 13, and 14. The molded portion 15 corresponding to the lower rear corner portion has a characteristic configuration in this embodiment and is particularly described hereinbelow. FIGS. 5, 6 and 7 show that this molded portion 15 has a base portion 31, a side wall portion 32 extending from the base portion 31, and a hollow seal portion 33 integrally formed with the side wall portion 32.

A front door 2 corresponding to the molded portion 15 has a mounting face 2a (see FIGS. 5, 6, and 7), which is almost parallel with the outer peripheral surface of the front door 2. FIG. 3 shows that the base portion 31 of the molded portion 15 is formed in such a way as to be curved, correspondingly to such a mounting face 2a. The base portion 31 of the molded portion 15 is attached to the mounting face 2a by clips 41 provided at predetermined intervals in a state in which the base portion 31 is made to abut against the mounting face 2a. On the other hand, the seal portion 33 of the molded portion 15 is formed nearly in a squarish manner in such a way as to correspond to the nearly squarish shape in plan view (or side view) of a sheet metal part provided at the lower rear corner portion of the front door 2. As a result of forming the seal portion 33 in such a way as to have a nearly squarish shape, the seal portion 33 fully extends over the outer periphery of the front door 2 thereby to sufficiently secure sealability during a closed state of the front door 2.

In other words, the weather strip 11 is configured so that the distance between the base portion 31 and the seal portion 33 has a maximum value at the squarish part of the corner portion (that is, length of the side wall portion 32, which is measured from the base portion 31, has the largest value at the squarish part). Therefore, the distance from the clip 41 to a region of the seal portion 33 increases as the region becomes closer to the squarish part thereof. In view of this respect, this embodiment has the following configuration so as to secure sufficient stability of a mounting state of the squarish part of the seal portion 33 and neighboring parts thereof.

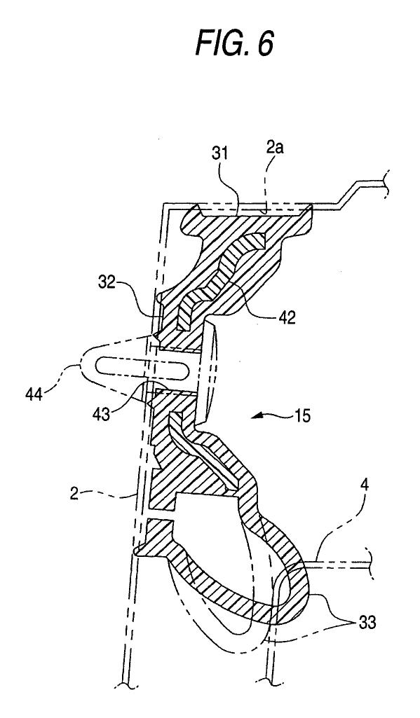

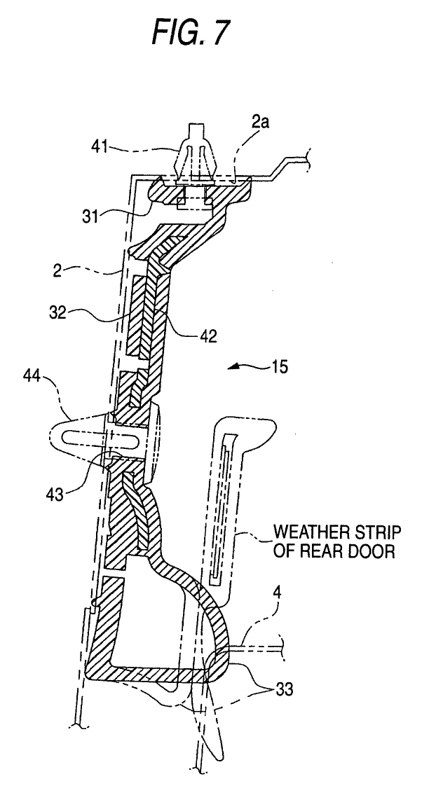

That is, inserts 42, each of which is formed like a flat plate (alternatively, a nearly triangular plate or a home-plate-like plate), are embedded in the side wall portion 32 corresponding to the corner portion. This insert 42 is made of a resin material having relatively high stiffness, for example, polyamide. Clip holes 43 are formed at plural places in each of parts of the side wall portion 32, which correspond to such inserts 42. The side wall portion 32 is attached to the sheet metal part provided at the lower rear corner portion of the front door 2 by fitting clips 44 (see FIGS. 6 and 7) serving as mounting means into the clip holes 43.

Next, operations and advantages of this embodiment of the aforementioned configuration are described hereinbelow.

In this embodiment, the front door 2 has the mounting face 2a that is almost parallel with the outer peripheral surface thereof. In the molded portion 15 corresponding to the lower rear portion, the base portion 31 is formed like a curved member correspondingly to such a mounting face 2a. Therefore, the molded portion 15 can be attached thereto by providing the base portion 31 along the mounting face 2a and using the clips 41.

Also, in this embodiment, the front door 2 and the rear door 3 are configured to be French doors. Thus, there is no other choice but to form the lower rear corner portion of the front door 2 nearly squarish. Under such circumstances, in this embodiment, the seal portion 33 of the molded portion 15 is formed like a nearly squarish member. Therefore, at the lower rear corner portion of the front door 2, the seal portion 33 sufficiently extends over the outer periphery of the front door 2, so that the sealability in the closed state of the front door 2 can sufficiently be secured.

Meanwhile, at the squarish part and neighboring parts thereof, the distance between the base portion 31 and the seal portion 33 is relatively large (that is, the thickness of the side wall portion 32, which is measured from the base portion 31, is relatively large). In view of this respect, in this embodiment, the flat-plate-like inserts 42 are embedded in the side wall portion 32 provided inside the seal portion 33. Therefore, sufficient stiffness of the corner portion is secured. Consequently, the sealability can be enhanced. Moreover, in the case of this embodiment, the inserts 42 are embedded therein, differently from the related art according to which there is a fear that the appearance of the door is deteriorated by attaching a separate member thereto. Consequently, the quality of the appearance can be prevented from being degraded.

Additionally, in this embodiment, plural clip holes 43 are provided corresponding to the inserts 42. Then, the clips 44 are made to respectively correspond to the clip holes 43, and fitted thereinto. Consequently, the molded portion 15 can stably be attached to the door. Hence, even in the vicinity of the seal portion 33, which is relatively distant from the base portion 31, sufficient mountability can be assured. Consequently, the mounting state of the seal portion can be extremely stabilized.

Incidentally, the invention is not limited to the described embodiment. For example, the invention may be practiced in the following manner. Needless to say, other applications and alterations, which are not exemplified in the following description, may be made.

(a) The aforementioned embodiment employs the configuration in which the clip holes 43 are provided corresponding to the inserts 42, and in which the clips 44 are attached thereto. However, the weatherstrip maybe configured so that a clip-like projection protruded nearly perpendicularly from the rear surface of each of the inserts is integrally formed with an associated one of the inserts, and that these projections are attached to the sheet metal part of the front door 2.

(b) In the aforementioned embodiment, the invention is embodied as the weather strip 11 attached to the outer periphery of the front door 2. However, an embodiment of the invention is not limited thereto. The invention can be applied to a weather strip attached to the outer periphery of the rear door 3.

(c) The configuration, in which the inserts are embedded as described above, is employed not only by the molded portion corresponding to the lower rear corner portion of the front door 2. Such a configuration may be employed by an upper rear corner portion (thus, the molded portion 16).

(d) Although each of the inserts 42 is made of polyamide in the aforementioned embodiment, the material of the insert 42 is not limited thereto. Materials, which are higher in stiffness or harder than the material of the weather strip 11, may be employed. The weather strip may be made of, for example, a thermoplastic resin material, such as polyester, sheet metal, or diecast material, such as aluminum alloy. Incidentally, in a case where the molded portion is made of rubber material, it is desirable that this rubber material does not melt when vulcanized.

(e) Although EPDM is employed as a material of the weather strip 11 in the aforementioned embodiment, the weather strip may be made of one of various other kinds of rubber, such as styrene-butadiene rubber, butadiene rubber, chloroprene rubber, butyl rubber, nitrile rubber, ethylene-propylene copolymerized rubber and acrylic rubber, or a synthetic resin material having rubber-like elasticity (in this case, it is assumed that such a synthetic resin material belongs to the category of a rubber material).

(f) Although the invention is embodied in the aforementioned embodiment in the case that both of the front door 2 and the rear door 3 are adapted to a French door, these doors are not necessarily adapted to a French door.

What is claimed is:

1. A door weather strip attachable to an outer periphery of an automobile door, comprising:
an extrusion portion;
at least one molded portion corresponding to a corner portion; and
wherein the door weather strip has a hollow seal portion, and the seal portion is formed at least in the corner portion so that shape in plan view of the seal portion is substantially squarish; and
an insert is embedded in an inner peripheral portion of the seal portion.

2. The door weather strip according to claim 1, wherein a part corresponding to the insert is adapted to be attached to the corner portion of the automobile door.

3. The door weather strip according to claim 1, wherein the automobile door is a front door; and
the part, in which the insert is embedded, is a lower rear corner portion.

4. A door weather strip comprising: a base portion attachable to an outer periphery of an automobile door; a side wall portion extending from the base portion to the outer periphery; and a hollow seal portion integrally formed with the side wall portion, the door weather strip, formed in a circular shape comprising an extrusion portion and at least one molded portion corresponding to a corner portion;
wherein at least in the corner portion, the base portion is formed like a curved member, and the seal portion is formed so that shape in plan view of the seal portion is nearly squarish; and
an insert is embedded in the side wall portion.

5. The door weather strip according to claim 4, wherein at least in the corner portion, the base portion is attached to a mounting face, which is nearly parallel with an outer peripheral surface of the automobile door, by a clip.

6. The door weather strip according to claim 4, wherein a part corresponding to the insert is adapted to be attached to the corner portion of the automobile door.

7. The door weather strip according to claim 4, wherein the automobile door is a front door; and
the part, in which the insert is embedded, is a lower rear corner portion.
